(19) United States
(12) Patent Application Publication
(10) Pub. No.: US 2004/0123671 A1
(43) Pub. Date: Jul. 1, 2004

(54) Method and apparatus for determining parameters of a flowing liquid

(76) Inventors: Aba Priev, Jerusalem (IL); Viktor Ponomarev, Rostov-Na-Donu (RU); Armen sarvazyan, Lambertville, NJ (US)

Correspondence Address: Mark Friedman, Bill Polkinghorn, Discovery Dispatch, 9003 Florin Way, Upper Marlboro, MD, 20772, US

(21) Appl. No.: 10/332,474

(22) PCT Filed: Jul. 10, 2001
(86) PCT No.: PCT/IL01/00635

(51) Int. Cl. G01F 1/20

(52) U.S. Cl. 73/861.19

(57) ABSTRACT

A method for measuring liquid flow, comprising the steps of delivering the liquid into a measuring cell having a measuring slot with at least one isolated electrode and at least two non-isolated electrodes, inducing fluctuations in the liquid flowing in the measuring slot, measuring electrical capacitance and electrical phase shifts correlated with the fluctuations, as well as a conductivity of the liquid, and obtaining flow parameters of the liquid from the electrical parameters. An apparatus for measuring the properties of a flowing liquid, comprising at least one measuring cell having at least one measuring slot, means for inducing flow fluctuations in the flowing liquid, and measuring means used to obtain liquid properties from the flow fluctuations.

### FIELD AND BACKGROUND OF THE INVENTION

The present invention relates to a method and apparatus for determining parameters of a flowing liquid or fluid, in particular its flow rate. The present invention can be used for example to determine the flow rate of milk during the milking process, as well as to determine other parameters of milk, such as its conductivity, viscosity, content of fat, protein, lactose, salt, and water.

There are many applications where it is desirable to determine the flow rate of a fluid. An object of this invention is to provide a method and an apparatus for measuring liquid flow rate and in particular, the flow rate and the quantity of milk obtained from a cow being milked by a mechanical milking apparatus. Another object of the present invention is to provide additional information useful for determining the composition of the liquid whose flow rate is being measured.

The determination of the amount of milk collected from a cow during milking, as well as the composition of the milk is of considerable importance in the dairy industry. Various patents related to the measurement of the flow rate of milk, which use various physical methods and principles have been issued. They include: US DO357,877 “Milk flow meter”; U.S. Pat. No. 3,829,584 and U.S. Pat. No. 3,946,113 “Continuous separating and standardizing of milk”; U.S. Pat. No. 4,231,324 “Milk quantity methods”; U.S. Pat. No. 4,325,028 “Examination apparatus for milk drawn from quarter mammae of a milk cow”; U.S. Pat. No. 4,364,269 “Flow meter for determining average rate of flow of liquid in a conduit”; U.S. Pat. No. 4,372,249 “Volumetric apparatus for milk and method of measuring the total quantity of milk collected from a cow in milking”; U.S. Pat. No. 4,433,577 “Apparatus for metering liquid flow”; U.S. Pat. No. 4,452,176 “Milk flow meter”; U.S. Pat. No. 4,485,763 “Method for direct measurement of the amount of milk obtained from a cow by a milking system during milking”; U.S. Pat. No. 4,974,448 “Electrodes for measuring the level of milk in flow meters”; U.S. Pat. No. 5,083,459 “Flow meter”; U.S. Pat. No. 5,116,119 “Methods and apparatus for measuring liquid flow”; U.S. Pat. No. 5,161,483 “Apparatus for the determining the yield of milk by a milking machine”; U.S. Pat. No. 5,245,946 “Methods and apparatus for measuring a value corresponding to the mass of a milk slug, and of the corresponding milk flow”; U.S. Pat. No. 5,313,833 “Milk flow meter”; U.S. Pat. No. 5,581,086 “Infrared light chamber for fluid measurement”; U.S. Pat. No. 5,720,236 “Milk meter”; U.S. Pat. No. 5,743,209 “System and method for monitoring and controlling milk production at dairy farms”; and U.S. Pat. No. 5,877,417 “Flow meter”.

Despite a great variety of inventions and proposed technologies for evaluating flow rate of liquids, in particular of milk, there are no devices that fully satisfy the requirements of the milk industry. The current invention is intended to comprehensively meet the needs of the dairy industry, and it also has applications in many other fields where accurate measurements of flow rates, in a wide range of variability of the flow parameters, are required.

### SUMMARY OF THE INVENTION

According to the present invention there is provided a method for measuring liquid flow, comprising the steps of: a) delivering the liquid into a measuring cell having a measuring slot with at least one isolated electrode, and at least two non-isolated electrodes; b) inducing fluctuations in the liquid while the liquid flows through the measuring slot; c) measuring electrical parameters of the fluctuating liquid; and d) obtaining flow parameters of the liquid from the electrical parameters.

According to the present invention, there is provided an apparatus for measuring the properties of a flowing liquid, comprising: a) at least one measuring cell having at least one measuring slot with a wall, the liquid flowing through the at least one measuring slot; b) means for inducing flow fluctuations in the flowing liquid; and c) measuring means used to obtain liquid properties from the flow fluctuations.

According to one embodiment of the apparatus of the present invention, the apparatus further comprises a composition measuring unit for measuring additional physical parameters of the liquid.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIG. 1 shows top and side cross-sectional views of one embodiment of the apparatus of the present invention.

FIG. 2 illustrates different embodiments of the measuring slot, showing different slot shapes and cross-sections.

FIG. 3 is a schematic representation of a four-channel measuring unit for separately evaluating flow parameters of milk from every tit of a cow.

FIG. 4 shows the apparatus of FIG. 1 in the milking process.

FIG. 5 shows a cross-sectional view of one embodiment of the unit for hydraulically modulating of flow rate in the measuring slot.

FIG. 6 is a cross-sectional view of another embodiment of the unit for hydraulically modulating of flow rate in the measuring slot.

FIG. 7 is a schematic representation of the longitudinal sectional view of the measuring slot, and a bock-diagram of an electronic circuitry for measuring phase shifts in the oscillatory component of the flow along the slot.

FIG. 8 shows another embodiment of the measuring slot, including additional isolated electrodes for measuring the phase shifts.

FIG. 9 is a schematic representation of the longitudinal sectional view of the measuring slot connected to a composition measuring unit.

FIG. 10 illustrates an embodiment of a composition measuring unit.

### DESCRIPTION OF THE PREFERRED EMBODIMENTS

The present invention discloses a method and apparatus for determining the parameters of a flowing liquid or fluid, in particular its flow rate. Specifically, the present invention discloses a method and apparatus for determining the flow rate of milk during the milking process, as well as for determining parameters of milk such as its conductivity, viscosity, content of fat, protein, lactose, salt, and water. The principles and operation of the apparatus according to the present invention may be better understood with reference to the drawings and the accompanying description.

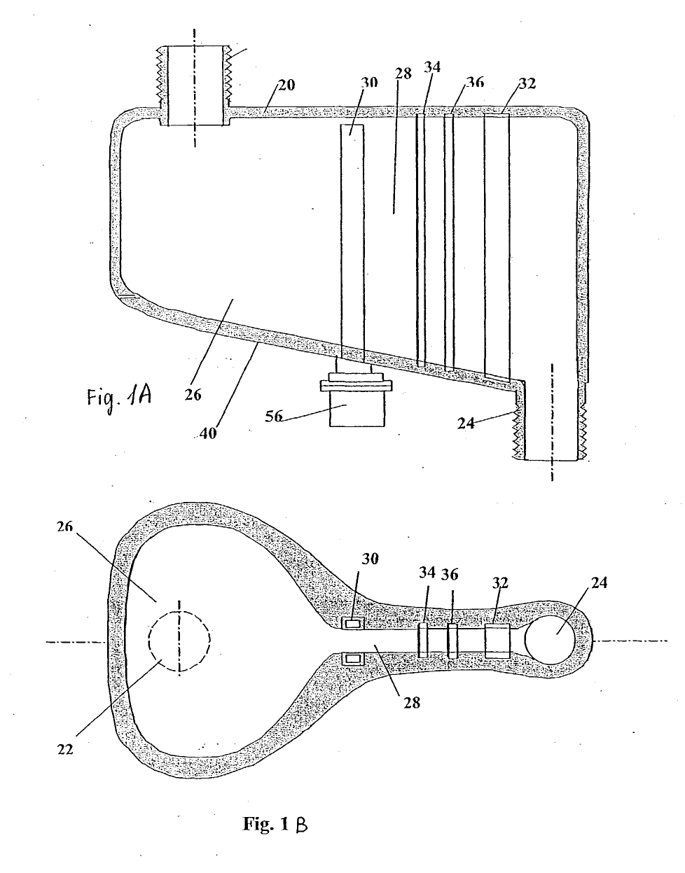

FIG. 1 shows the cross-sectional views of a preferred embodiment of the apparatus of the present invention in a side cross-sectional view (A) and a top cross-sectional view (B). The apparatus has a body 20 with an inlet 22 and an outlet 24, a receiving chamber 26 attached to a measuring slot 28 with a slant bottom 40, and an elastic tube 30 for hydraulically modulating the flow rate in measuring slot 28. Elastic tube 30 is preferably positioned at least partially on an inside wall of, and surrounding slot 28, thus being in physical contact with the liquid, and preferably extends for a limited length along the flow path in slot 28. It is imparted oscillations (fluctuations) by a device 56. An isolated electrode 32 used for both capacitance and electrical phase shift measurements, and two non-isolated electrodes 34 and 36 used for conductivity measurements, are positioned in measuring slot 28. The capacitance measurement needs two “plates” for a capacitor, electrode 32 being one, and one of the electrodes 34 or 36 being the other, this other electrode serving as a “common” electrode to both capacitance and conductivity measurements. Hereinafter, the capacitance and phase shifts measurements will be referred to as being done on “electrode 32”, with the understanding that a capacitance measurement needs of course a capacitor (two plate) structure.

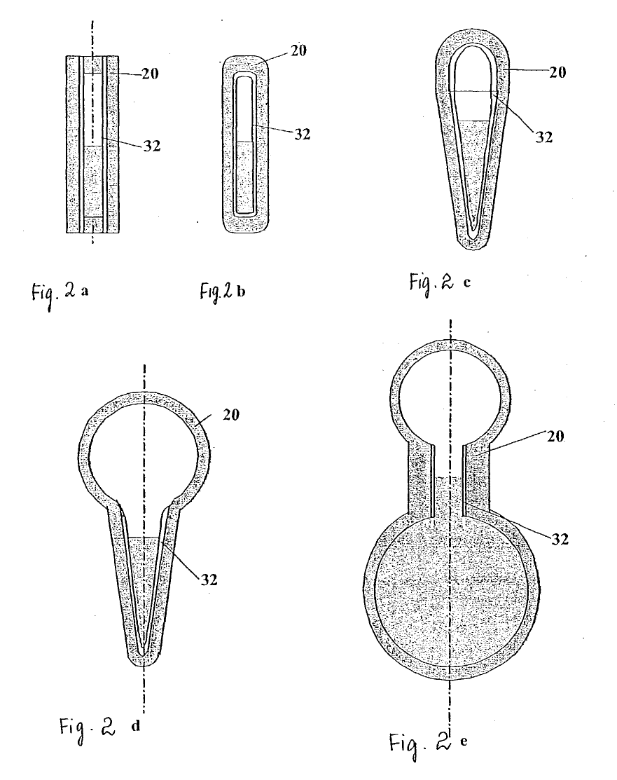

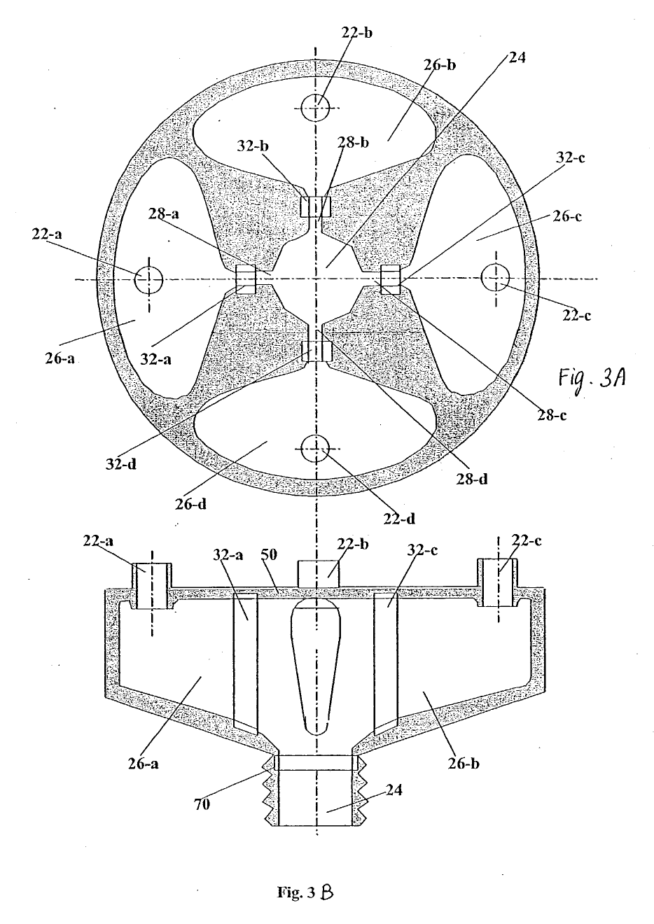

Electrode 32 may have various shapes, some of which are shown in FIG. 2. It may be divided into two sections that serve themselves as capacitor “plates”, again with various shapes, or may have any shape that enables a capacitance measurement. Measuring slot 28 may also have different shapes and cross-sections, as illustrated in FIGS. 2a-e. Slot 28 may be divided into subsections along its length, and more than one slot 28 may be incorporated in one unit 20. The basic unit embodied by body 20 can be joined with three other such units, as shown in FIG. 3, to fit the shape of the four tits of a cow, each unit 20 applied to one tit.

FIG. 3 shows such a “four-channel” or more generally a “multi-channel” measuring unit 50 in both top cross-section (A) and side cross-section (B). Unit 50 can be used for separately evaluating flow parameters of milk from each tit of a cow. In this device there are four inlets 22a-d, four receiving chambers 26a-d, four measuring slots 28a-d, four isolated electrodes 32a-d and one common outlet 24′, as well as one common electrode 70.

It should be apparent to anyone versed in the art that although the preferred embodiment of body 20 is preferably made of a rigid material, flexible materials such as rubber or flexible plastic may also be used. In such cases, elastic tube 30 may be positioned entirely or partially outside slot 28, its pulsations transmitted to the fluid through the walls of slot 28.

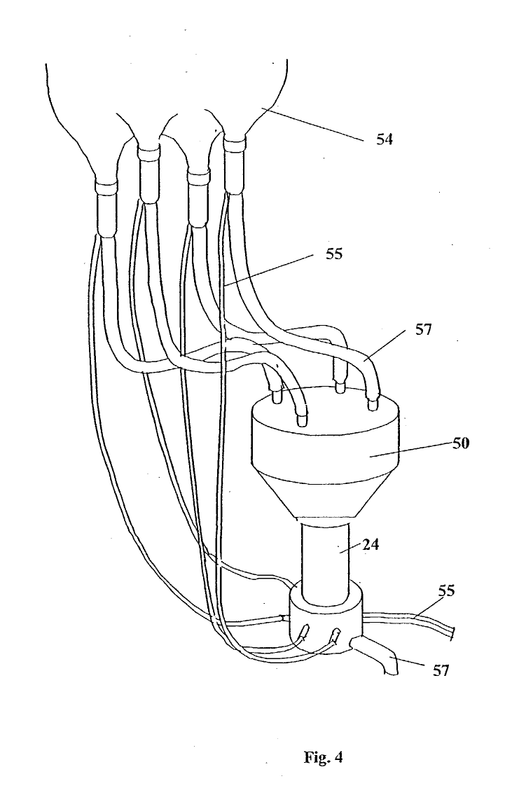

FIG. 4 shows a unit 50 attached through four identical flexible tubes 52 to tits 54, during a milking process. Tubes 55 attached through outlet 24 to the bottom of unit 50 are used for applying vacuum during milking, while tubes 57 are used for milk flow out of unit 50. Tubes 55′ are also used for applying vacuum.

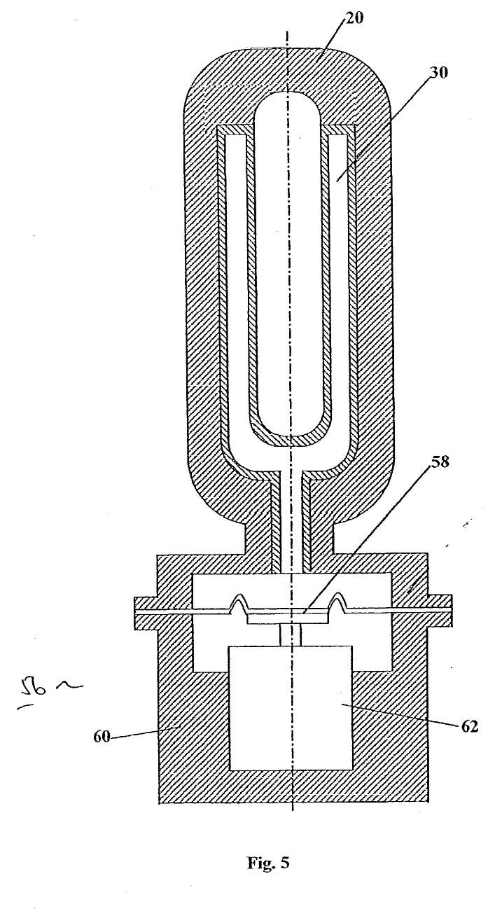

The flow rate measurement principle is based on the sensing of fluctuations in the flow rate of the liquid moving in slot 28 by isolated electrode 32. The fluctuations are induced by hydraulically modulating elastic tube 30 that surrounds measuring slot 28, the modulation produced by a device 56 (FIG. 1) that can be for example an oscillating pump. One embodiment of such a device is shown in more detail in FIG. 5. It includes an oscillating membrane 58 situated in a chamber 60 and driven in an oscillatory motion by a driver 62. Device 56 can be attached to tube 30 in any way that ensures the transfer of the membrane oscillations to the elastic tube. Such attachments are well known to those versed in the art.

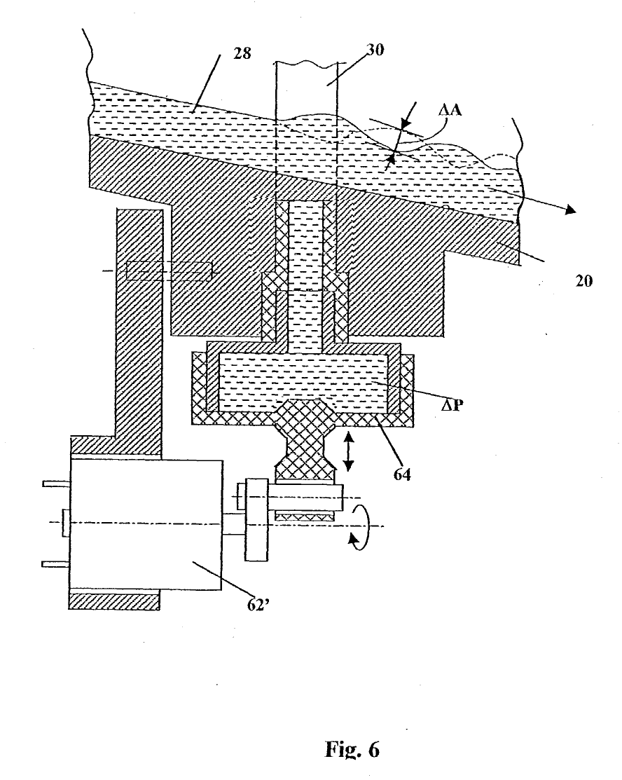

Another embodiment of a device for hydraulically modulating of flow rate in the measuring slot is shown in FIG. 6. Here a driver 62′ is moving a rubber membrane 64. Changes in pressure ΔP induced by the membrane are translated into changes ΔA in the amplitude of a liquid fluctuation in slot 28 (equivalent to Δh; i.e. a change in the height of the liquid in the measuring slot).

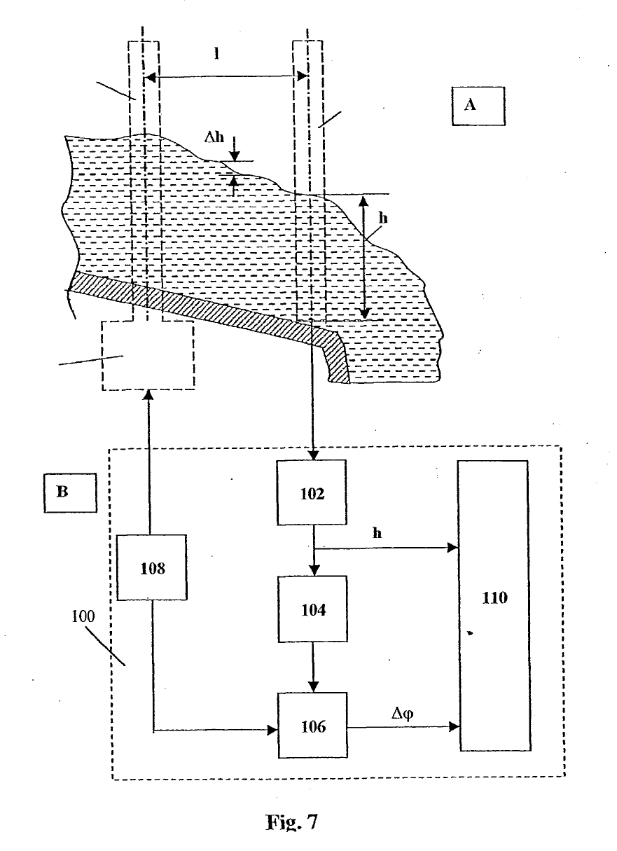

FIG. 7 shows schematically in (A) a longitudinal sectional view of the measuring slot and in (B) a block-diagram of an electronic circuitry 100 used for measuring the phase shifts in the flowing liquid. Circuitry 100 typically includes a capacitance measuring block 102, a band-pass filter 104, a phase detector 106, a VCO 108, and a data processing unit 110.

In a typical operating procedure for measuring the flow rate, the fluid (e.g. milk) flows through inlet 22 of body 20 and reaches receiving chamber 26, in which the natural pulsation of the fluid flow is reduced. From chamber 26, the fluid flow passes through measuring slot 28, mostly above slant bottom 40. Device 56 induces fluctuations of a given frequency and amplitude in the liquid height “h” through the modulation of elastic tube 30 that surrounds slot 28. Electrode 38 measures the capacitance, which depends on the level of the liquid h, see eqn. 3 below. The capacitance will vary in time with a frequency equal to that of the liquid fluctuations, but phase shifted. The phase shift is obtained by measuring the capacitance time dependence and correlating it with the induced fluctuations' time dependence. The quantity of liquid Q is given by the formula:

Q=kₗ·V·h (1)

where V is the flow rate of the liquid, h is the average level of the liquid in the measuring slot, and k₁ is a constant. The flow rate V itself is given by

V=k₂/δφ (2)

where k₂ is another constant, and δφ is the electrical phase shift between the capacitance measured on electrode 32 and the fluctuations imposed on the liquid by elastic tube 30. Means to apply and read signals to an electrode, and obtain both capacitance readings and the phase shift between applied and read signals are well known in the art. The phase shift is directly correlated with the induced fluctuations in the flowing liquid. The level h is found from a capacitance measurement using electrode 32 through the formula:

h=k₃·(C·C₀) (3)

where C is the capacitance of the electrode immersed in the flowing liquid, C₀ is the capacitance without liquid flow, and k₃ is a constant. It is evident that by obtaining V from the measured phase shift, eqn. 2, and by obtaining h from the capacitance measurement, eqn. 3, one can calculate the quantity Q in eqn. 1, if all the constants were determined separately.

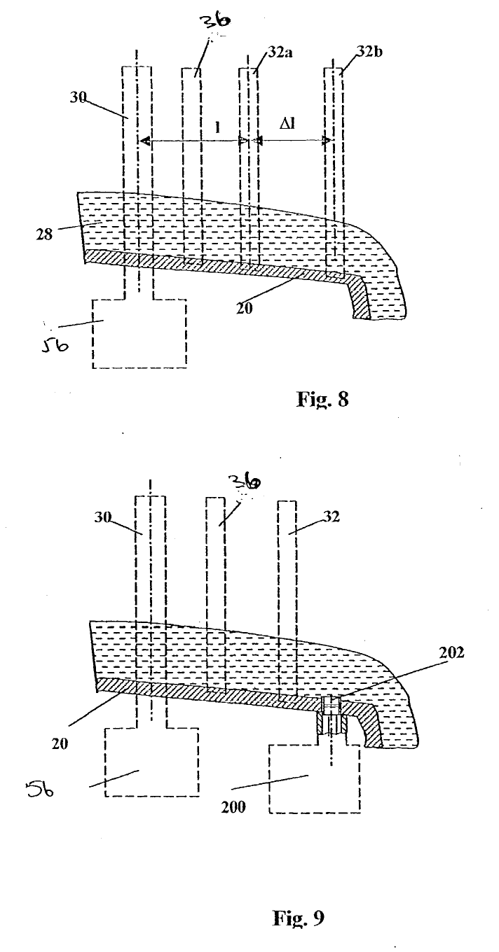

FIG. 8 illustrates another embodiment of a system or apparatus for measuring the phase shift in the oscillatory component of the flow along a slot 28, here by using two isolated electrodes 32a and 32b. In this case, the fluid flow rate is given by the formula:

V=k₄/δφ (4)

where k₄ is a constant, and δφ is the phase shift of signals on electrodes 32a and 32b vs. the fluctuations at tube 30.

In equations 1-4, constants k₁-k₄ can be found experimentally by calibration. While k₃ is related to h by a linear or non-linear relationship, depending on the type of fluid flow, which, in turn, depends on the shape of slot 28. For example, for the shapes in FIGS. 2a and b, this dependence is typically close to linear, while for the shapes in FIGS. 2c, d this dependence is nonlinear. In the case of a gaseous fluid, i.e. when air bubbles in various amounts exist in the fluid, it is preferable to use the cross-sections of measuring slot 28 shown on FIGS. 2c, d, and e.

In a multi-channel measuring unit, like unit 50 in FIGS. 3,4, the flow rate can be determined independently in each channel according to qᵢ=F·hᵢ, where qᵢ is the flow rate in channel i, hᵢ is the measured level of the liquid in channel i, and F is a polynomial function determined experimentally

The various embodiments of the apparatus for measuring the liquid flow rate, as described above and shown in FIGS. 1-8, can be used advantageously to also determine, on-line and in real time, the composition of the liquid, i.e. the concentration of its various components. FIG. 9 is a schematic representation of a longitudinal sectional view of measuring slot 28 that is connected to an additional composition measuring unit 200. Unit 200 is preferably attached to the bottom of unit 20 and has a piston 202 used for delivering a small fraction of the liquid that flows through unit 20 and slot 28 into composition measuring unit 200, and returning that fraction of the fluid back into measuring slot 28. Composition measuring unit 200 includes acoustical and electrical measurement as well as heating and thermostating elements, that are employed in measuring acoustical and electrical parameters of the fluid as function of temperature.

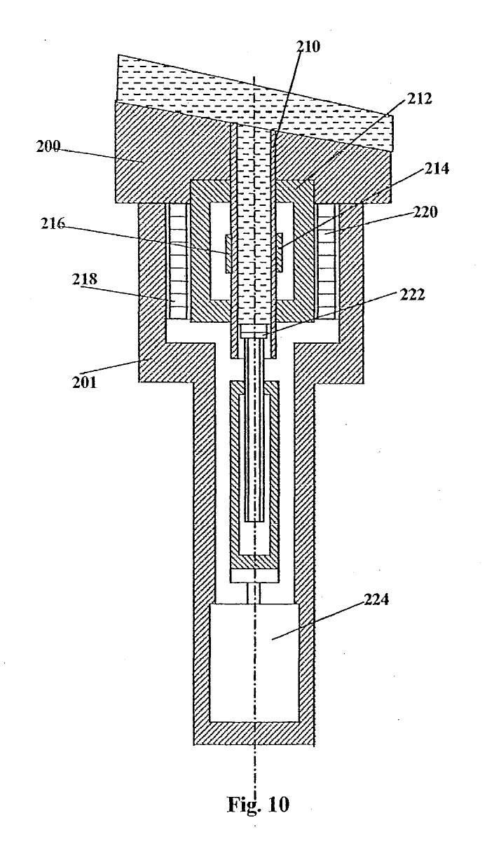

FIG. 10 illustrates an embodiment of unit 200 with a body 201, with the main elements mentioned above, including acoustical resonator cell 210, a thermostating chamber (thermal jacket) 212, piezotransducers 214 and 216, Peltier elements 218 and 220, a piston 222 and a driving motor 224 enclosed in body 201. Piston 222 and driver 224 are used for delivery of a small fraction of the liquid into the measuring acoustic resonator cell tube 210, and for returning that fraction of the fluid back into the measuring slot. Piezoelectric transducers 214 and 216 are used to generate acoustical standing waves in acoustical cell 210, for determining additional parameters of the liquid (density, sound velocity, sound attenuation, and temperature derivatives of these parameters). Thermal jacket 212, Peltier elements 218 and 220 and a heat sink 230 are used as a temperature-control system.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for measuring liquid flow, comprising the steps of:
a) delivering the liquid into a measuring cell having a measuring slot with at least one isolated electrode, and at least two non-isolated electrodes;
b) inducing fluctuations in the liquid while the liquid flows through said measuring slot;
c) measuring electrical parameters of said fluctuating liquid using said electrodes; and
d) obtaining flow parameters of the liquid from said electrical parameters.

2. The method of claim 1, wherein said flow parameters are selected from the group consisting of flow rate and flow quantity.

3. The method of claim 2, wherein said measuring step is performed by an isolated electrode, and wherein said electrical parameters include capacitance and phase shifts.

4. The method of claim 3, wherein said inducing step further includes modulating the liquid flow in said measuring slot to obtain said fluctuations, and wherein said measuring step further includes electrically determining a capacitance and an electrical phase shift correlated with said fluctuations.

5. The method of claim 1, further comprising the step of providing a composition measuring unit for measuring additional physical parameters of the liquid.

6. The method of claim 5, wherein said additional parameters of the liquid are selected from the group consisting of sound velocity, sound attenuation, temperature derivative of sound velocity, and temperature derivative of sound attenuation.

7. The method of claim 1, wherein said fluctuating liquid is milk.

8. An apparatus for measuring the properties of a flowing liquid, comprising:
a) at least one measuring cell having at least one measuring slot with a wall, the liquid flowing through said at least one measuring slot;
b) means for inducing flow fluctuations in the flowing liquid; and
c) measuring means used to obtain liquid properties from said flow fluctuations.

9. The apparatus of claim 8, whereby said means for inducing said flow fluctuations include at least one pulsating segment on said wall of said at least one measuring slot.

10. The apparatus of claim 8, wherein said pulsating segment is, an elastic tube.

11. The apparatus of claim 8, wherein said measuring means include at least one isolated electrode used for measuring capacitance and electrical phase shifts correlated with said fluctuations, and at least two conducting electrodes for measuring electrical conductivity.

12. The apparatus of claim 8, further comprising a composition measuring unit for measuring additional physical parameters of the liquid.

13. The apparatus of claim 12, wherein said composition measuring unit includes acoustical measurement means.

14. The apparatus of claim 13, wherein said acoustical means include piezotransducers capable of generating and measuring acoustical standing waves.

15. A method for measuring the flow rate of a liquid, comprising the steps of:
a) delivering the liquid into a measuring cell having a measuring slot with at least one isolated electrode, and at least one non-isolated electrode;
b) inducing fluctuations in the liquid;
c) measuring the capacitance of the liquid using said electrodes; and
d) obtaining a phase shift using said fluctuations and said capacitance, whereby the flow rate is calculated from said phase shift.
